(19) United States
(12) Patent Application Publication
(10) Pub. No.: US 2024/0046137 A1
(43) Pub. Date: Feb. 8, 2024

(54) REDUCED DENSITY MATRIX ESTIMATION FOR PARTICLE-NUMBER-CONSERVING FERMION SYSTEMS USING CLASSICAL SHADOWS

(71) Applicant: Microsoft Technology Licensing, LLC, Redmond, WA (US)

(72) Inventor: Guang Hao LOW, Redmond, WA (US)

(73) Assignee: Microsoft Technology Licensing, LLC, Redmond, WA (US)

(21) Appl. No.: 17/822,104

(22) Filed: Aug. 24, 2022

Related U.S. Application Data
(60) Provisional application No. 63/369,643, filed on Jul. 27, 2022.

(51) Int. Cl. G06N 10/60

(52) U.S. Cl. CPC G06N 10/60

(57) ABSTRACT

A computing system including a classical computing device, including a processor that generates a Haar-random unitary matrix. The processor further computes a single-particle-basis fermion rotation based at least in part on the Haar-random unitary matrix and outputs the single-particle-basis fermion rotation to a quantum computing device. The quantum computing device receives a specification of a fermion wavefunction and further receives the single-particle-basis fermion rotation. The quantum computing device further applies the single-particle-basis fermion rotation to the fermion wavefunction. The quantum computing device further measures the rotated fermion wavefunction to obtain a classical shadow measurement result. The processor of the classical computing device further receives the classical shadow measurement result. The processor further estimates a k-reduced density matrix (k-RDM) element of a k-RDM of the fermion wavefunction based at least in part on the classical shadow measurement result and the Haar-random unitary matrix. The processor further outputs the k-RDM element.

### CROSS REFERENCE TO RELATED APPLICATIONS

This application claims priority to U.S. Provisional Patent Application Ser. No. 63/369,643, filed Jul. 27, 2022, the entirety of which is hereby incorporated herein by reference for all purposes.

### BACKGROUND

Fermions are particles with wavefunctions that cannot simultaneously occupy the same quantum state. For example, electrons, protons, and neutrons are fermions. In quantum chemistry, it is frequently desirable to estimate the value of an observable phenomenon, or simply observable, for a system that includes fermions. The observable may, for example, be an energy or a dipole moment. The value of the observable may be used when further approximating the behavior of a quantum-chemical system, such as when estimating the amount of energy absorbed or released by a chemical reaction.

### SUMMARY

A computing system including a classical computing device is provided. The classical computing device includes a processor that generates a Haar-random unitary matrix, computes a single-particle-basis fermion rotation based at least in part on the Haar-random unitary matrix, and outputs the single-particle-basis fermion rotation to a quantum computing device. The quantum computing device receives the single-particle-basis fermion rotation and a specification of a fermion wavefunction. The fermion wavefunction is specified over a plurality of fermions in a particle-number-conserving fermion system that occupy a plurality of modes. The quantum computing device further applies the single-particle-basis fermion rotation to the fermion wavefunction to obtain a rotated fermion wavefunction. The quantum computing device measures the rotated fermion wavefunction to obtain a classical shadow measurement result that encodes an estimate of which of the modes are occupied by the fermions. The processor of the classical computing device further receives the classical shadow measurement result. The processor estimates a k-reduced density matrix (k-RDM) element of a k-RDM of the fermion wavefunction based at least in part on the classical shadow measurement result and the Haar-random unitary matrix. The processor outputs the k-RDM element to an additional computing process.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 schematically shows a computing system that includes a quantum computing device and a classical computing device, according to one example embodiment.

FIG. 2 shows a data flow that occurs at the computing system of FIG. 1 in some examples when an estimated value of an observable is computed.

FIG. 3A shows a flowchart of an example method that may be performed at the computing system of FIG. 1.

FIG. 3B shows additional steps of the method of FIG. 3A that may be performed in some examples.

FIG. 4 shows a schematic view of an example computing environment in which the computing system of FIG. 1 may be instantiated.

### DETAILED DESCRIPTION

Methods of determining the properties of fermion wavefunctions typically have high computational complexity. For example, in the most general representation of a fermion wavefunction as a sum of Slater determinants, the complexity scales exponentially with the number of modes. In some systems of fermions, such as those in which strong correlation is present, the complexity of computing properties of the system may be high even when theoretically optimal algorithms are used. Though specialized compact representations, such as tensor network states and electron density, may facilitate tractable parameter counts and often allow for sufficient accuracy, these approaches have low accuracy for some systems of fermions.

Quantum computing devices allow for the use of algorithms that provide significant reductions in computational complexity in many quantum chemistry problems. For example, a quantum computing device may be used to implement a variational quantum eigensolver at which the ground state energy of a Hamiltonian is computed. In many quantum chemistry applications of quantum computing devices, a plurality of k-reduced density matrix (k-RDM) elements [symbol] αₚ_{₁}^{†} . . . αₚ_{ₖ}^{†}α_{q}_{ₖ} . . . α₁ [symbol] are estimated. In the above expression, k is the number of ladder operator pairs with which the matrix element is computed. The k-reduced density matrix elements are then summed to compute an estimated value of an observable of interest, such as an energy or a dipole moment. For some special cases such as 1-RDMs or specific groupings of k-RDMs, these methods of computing k-RDM elements are not generally applicable.

Quantum algorithms that make use of classical shadows have recently been investigated as potential solutions to the problem of efficiently computing k-RDM elements for systems of fermions. Using classical shadows, exponentially many observables that are either local or low-rank may be predicted within a constant error threshold with polynomially many measurements. These observables may be computed in either a random single-qubit basis or a global Clifford basis chosen apriori. These algorithms that make use of classical shadows may be extended to fermions through fermion-to-qubit mappings such as the Jordan-Wigner mapping or the Bravyi-Kitaev mapping. However, observables expressed naturally in terms of fermion operators do not translate easily to expression in terms of Pauli operators. Expressing fermion observables in terms of Pauli operators incurs considerable overhead, such that estimating a k-RDM on n modes requires [symbol] ( [symbol] ^{(k)}) qubit shadows.

In order to reduce the number of classical shadows used in the estimation of a k-RDM element, the classical shadows may be tailored to fermion wavefunctions of interest. In one previous approach, random fermion rotations were applied to the fermion wavefunctions when computing the classical shadows. However, even when the fermion rotations are randomized in the Majorana basis,

$$( ( \begin{matrix}n \\ k\end{matrix} ) {k}^{3 / 2} )$$

classical shadows are required to estimate a k-RDM on n modes. In addition, in this previous approach, randomization over number-conserving fermion permutations required bootstrapping classical shadows in a random single-qubit basis, and hence required a specific choice of fermion-to-qubit mapping to achieve tomographic completeness. This use of bootstrapping further increased the computational complexity. In the Majorana representation, the sample complexity is optimal, since a k-RDM decomposes into

$$( \begin{matrix}n \\ k\end{matrix} )$$

Majorana operators. “Sample complexity” refers here to the number of sampled values of the k-RDM that are needed to achieve a level of error below a specified threshold.

The devices and methods described herein overcome the previous expectation that the sample complexity of classical shadows for systems of fermions cannot be improved in general. As discussed in further detail below, the random bases of the classical shadows may be tailored to observables that more succinctly describe the problem of computing k-RDM elements, in comparison to applying random rotations in the Majorana basis. For example, many electronic-structure Hamiltonians are more easily expressed using number-conserving k-RDMs rather than using Majorana representations. In addition, many electronic-structure Hamiltonians exhibit particle-number symmetry. Thus, a random basis that respects this symmetry may be selected. The basis may also be selected such that common observables are low rank. Specifically, random basis measurements are selected with respect to the one-body number-conserving fermion rotation, which is given by the following equation:

U(u)=e^{Σ}^{_{pq}}^{ln(u)}^{_{pq}}^{(α}^{ₚ}^{^{†}}^{α}^{_{q}}^{-α}^{_{q}}^{^{†}}^{α}^{ₚ}⁾,

u˜Haar( [symbol] ₙ)

In the above equation, αₖ^{†} is a creation operator, α_{q} is an annihilation operator, [symbol] ₙ is the space of rotations, ˜ denotes “sampled from,” and Haar( ) denotes a Haar integral. In addition, ln(u)_{pq} in the above equation indicates the entry of the matrix logarithm ln(u) located in the pth row and the qth column.

Using the rotation expressed above may result in significant compute savings. The one-body number-conserving fermion rotation may be implemented with only [symbol] (n²) quantum gates in any qubit representation of fermions. In addition, unlike the rotations used in previous methods of using classical shadows to compute k-RDM elements, the one-body number-conserving fermion rotation is tomographically complete.

Although one-body number-conserving fermion rotations may reduce the sample complexity of computing the k-RDM elements, the above equation for the rotation is not a t-design except in the one-particle subspace. In addition, Haar integrals in the random basis are polynomials of degree t=3η, where η is the number of fermions. Since the degree of the polynomial may be very large, the Haar integrals may be computationally expensive to evaluate.

Computing the k-RDM elements using the basis of number-conserving fermion rotations may have significantly higher sample efficiency compared to using the basis of number-conserving fermion permutations. The plurality of k-RDMs may be estimated in parallel to an average standard deviation e using a number of samples given by the following:

$$N = \frac{1}{{ϵ}^{2}} ( \begin{matrix}n \\ k\end{matrix} ) {( 1 - \frac{η - k}{n} )}^{k} \frac{1 + n}{1 + n - k} = ( \frac{1}{{ϵ}^{2}} \frac{{η}^{k}}{k !} )$$

Compared to prior approaches that scale according to [symbol] ^{(k)}/∈², the sample complexity given by the above equation is a super-exponential improvement, since n may be arbitrarily larger than η. Even the worst-case scaling that occurs in half-filling examples, where η=n/2, the sample complexity is given by

$$N = ( \frac{1}{{ϵ}^{2}} \frac{{( n / 4 )}^{k}}{k !} )$$

which is smaller by a factor of 4^{k} whenever k<<n, as is often the case. Moreover, the estimation algorithm is computationally efficient for any fixed k.

Using the devices and methods discussed herein, entangled fermion properties may be efficiently computed for frequently applicable classes of fermion wavefunctions and systems. In addition, the classical shadows may be encoded using a small amount of data. The methods discussed herein may quickly converge to accurate estimates of common observables of interest and may be applied to any fermion wavefunction.

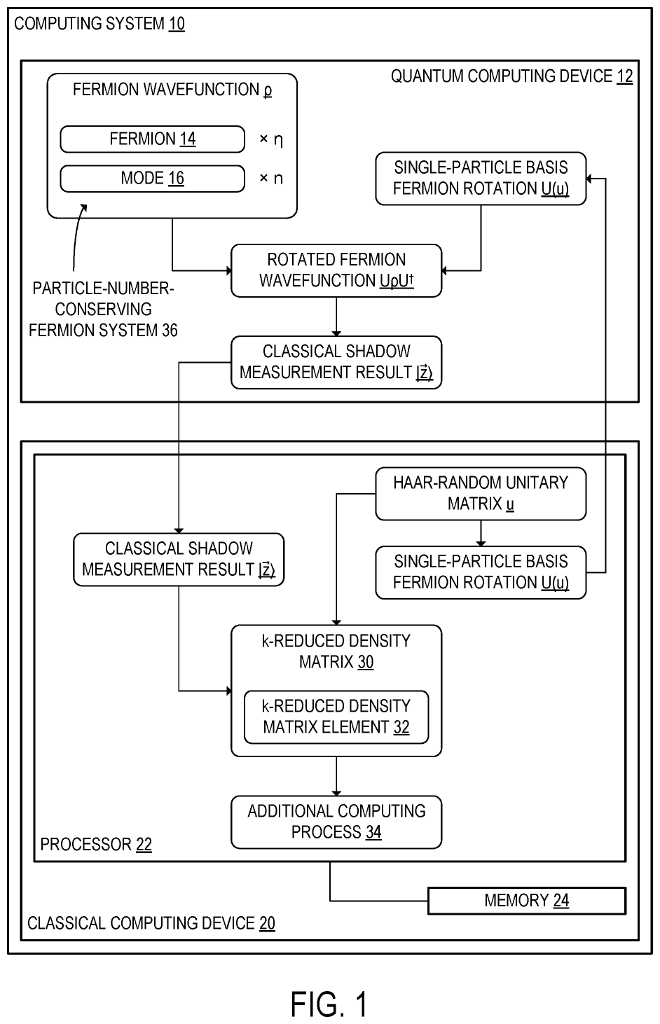

Turning now to FIG. 1, a computing system 10 is schematically shown, according to one example embodiment. The computing system 10 depicted in FIG. 1 includes a quantum computing device 12 that is communicatively coupled to a classical computing device 20. At the quantum computing device 12, a plurality of qubits are instantiated at a qubit encoding surface. The quantum computing device 12 may include a plurality of logical qubits that are each formed from a respective plurality of physical qubits. The plurality of physical qubits that form each logical qubit may be used to encode the state of the logical qubit and perform quantum error correction. At the quantum computing device 12, gates and measurements are performed on the logical qubits to perform quantum computations. The quantum computing device 12 may, for example, be a topological quantum computing device.

The classical computing device 20 shown in FIG. 1 includes a processor 22. The classical computing device 20 of FIG. 1 further includes memory 24 that is communicatively coupled to the processor 22. The classical computing device 20 is configured to receive measurement results from the quantum computing device 12 and perform further computations on those measurement results at the processor 22. In some examples, the quantum computing device 12 may also receive control inputs from the classical computing device 20.

The processor 22 of the classical computing device 20, as shown in FIG. 1, generates a Haar-random unitary matrix u with dimension n×n. As discussed in further detail below, the Haar-random unitary matrix u may be randomized with respect to orbital rotations U(u). In addition, the processor 22 computes a single-particle-basis fermion rotation U(u) based at least in part on the Haar-random unitary matrix u. The processor 22 further outputs the single-particle-basis fermion rotation U(u) to the quantum computing device 12.

As shown in the example of FIG. 1, the quantum computing device 12 receives a specification of a fermion wavefunction ρ over η fermions 14 in a particle-number-conserving fermion system 36 that occupy n modes 16. The fermions 14 may, for example, be electrons and atomic nuclei included in a molecule for which the fermion wavefunction ρ is simulated. The specification of the fermion wavefunction p may, for example, be received as an eigenstate of a Hamiltonian.

The quantum computing device 12 receives the single-particle-basis fermion rotation U(u) from the classical computing device 20. The quantum computing device 12 subsequently applies the single-particle-basis fermion rotation U(u) to the fermion wavefunction to obtain a rotated fermion wavefunction UρU^{†}.

The quantum computing device 12 further measures the rotated fermion wavefunction UρU^{†} to obtain a classical shadow measurement result |\vec{z} [symbol] . The classical shadow measurement result |\vec{z} [symbol] is a measurement of a classical shadow \vec{z} that encodes an estimate of which of the modes are occupied by the fermions. The quantum computing device 12 transmits the classical shadow measurement result |\vec{z} [symbol] to the classical computing device 20, which receives and further processes the classical shadow measurement result |\vec{z} [symbol] .

When a classical shadow \vec{z} of the fermion wavefunction ρ following a random change in basis U is sampled with a probability distribution given by [symbol] \vec{z}|U(u)ρU^{†}(u)|\vec{z} [symbol] , the quantum state may be approximated by averaging over ρ≈ [symbol] [U^{†}(u)|\vec{z} [symbol] [symbol] \vec{z}|U(u)]. The outcome of this approximation procedure is given by the following measurement channel:

[symbol]

_{∧}_{ⁿ}ᵤ_{ₙ}(ρ)= [symbol] _{i˜U,|\vec{z}} [symbol] _{˜UρU}_{^{†}}[U^{†}(u)|\vec{z} [symbol] [symbol] U(u)]

Inverting the measurement channel produces an unbiased estimate of the density matrix:

ρ= [symbol] _{u˜U,|\vec{z}} [symbol] _{˜UρU}_{^{†}}[\hat{β}_{u,\vec{z}}]

\hat{ρ}_{u,\vec{z}}= [symbol] _{∧}_{ⁿ}_{U}_{ₙ}⁻¹[U^{†}(u)|\vec{z} [symbol] [symbol] \vec{z}|U(u)]

Inverting the measurement channel allows the expected values of arbitrary observables to be estimated without explicitly computing p. The expected value of an observable may be estimated as:

Tr[Oρ]= [symbol] _{u˜U,|\vec{z}} [symbol] _{˜UρU}_{^{†}}Tr[O\hat{ρ}_{u,\vec{z}}]

Given a finite number of N classical shadows and corresponding Haar-random unitary matrices (\vec{z}, uⱼ), the estimate of O is given by:

$$= \frac{1}{N} {\sum }_{j ∈ [ N ]} Tr [ O {\hat{ρ}}_{{u}_{j} , {\vec{z}}_{j}} ]$$

Accordingly, the computing system 10 may estimate O without having to directly compute \hat{ρ}. Since the dimension of \hat{ρ} may be large, the above procedure for estimating O may allow for savings in processing time and memory usage.

Additional formalism regarding the classical shadows \vec{z} is now provided. A classical shadow of a quantum state ρ is a bitstring \vec{z}∈ [symbol] associated with a measurement result |\vec{z} [symbol] in a random basis indexed by u. The probability of measuring a particular value of \vec{z} is given by:

Pr[\vec{z}]=Tr[ [symbol] \vec{z}|U(u)ρU^{†}(u)|\vec{z} [symbol] ]

The above equation for the probability indicates that the inverse state U^{†}(u)|\vec{z} [symbol] [symbol] \vec{z}|U(u) is an estimate of ρ. The quantum channel corresponding to the measurement of the inverse state is given by the equation for [symbol] _{∧}_{ⁿ}_{U}_{ₙ}(φ discussed above. In addition, as discussed above, the unbiased estimate \hat{ρ} of the fermion wavefunction ρ may be obtained by inverting the measurement channel, and the value of the observable O may be estimated by computing the trace of O applied to the unbiased estimate \hat{ρ}. As discussed above, computing the estimated value of the observable O using classical shadows may result in processing time and memory savings. Although the unbiased estimate \hat{ρ} may be difficult to express explicitly due to having a large dimension, explicit computation of \hat{ρ} may be avoided when the measurement channel is efficiently invertible.

The variance of the estimate of O is given as follows:

$$𝔼 [ {Tr ( O \hat{ρ} )}^{2} - {Tr ( O ρ )}^{2} ] = {𝔼}_{u ∼ 𝒰 , \vert \vec{z} 〉 ∼ U ρ {U}^{†}} [ {〈 \vec{z} \vert U {𝒰}_{- 1}^{} ( O ) {U}^{†} \vert \vec{z} 〉}^{2} ] - {Tr [ O ρ ]}^{2} \leq {max}_{ρ} {𝔼}_{u - 𝒰 , \vert \vec{z} 〉 ∼ U ρ {U}^{†}} [ {〈 \vec{z} \vert U {𝒰}_{- 1}^{} ( O ) {U}^{†} \vert \vec{z} 〉}^{2} ] = {‖ O ‖}_{shadow}^{2}$$

The variance of the estimate of O is upper bounded by the shadow norm ∥O∥_{shadow}².

The measurement channel [symbol] _{∧}_{ⁿ}_{U}_{ₙ}(φ and the shadow norm ∥O∥_{shadow}² may be expressed in terms of t-designs. The equations for the measurement channel and the shadow norm may be written in terms of the twirling operator

[symbol]

_{t,n,η}=∫_{u˜U}_{ₙ}(U^{†}(u)|\vec{z} [symbol] [symbol] |U(u))^{⊗T}du

as follows:

$${{∧}^{n} {𝒰}_{n}}_{} ( ρ ) = \vert \vert {Tr}_{1} [ {2 , n , η}_{} ( ρ ⊗ {I}_{} ) ]$$

$${‖ O ‖}_{shadow}^{2} = {max}_{ρ} \vert \vert Tr [ {T}_{3 , n , η} ( ρ ⊗ {𝒰}_{- 1}^{} ( O ) ⊗ {𝒰}_{- 1}^{} ( O ) ) ]$$

In the above equations, Iₛ=Σ_{\vec{z}}|\vec{z} [symbol] [symbol] \vec{z}|, and | [symbol] |=Tr [ [symbol] ] is dimension of ρ.

Formalism that may be used to describe the rotations applied to the fermion wavefunction ρ is discussed below. The following definitions are provided. The basis elements of an n-dimensional complex vector space Vₙ are defined as αₖ^{†}|0 [symbol] ≐|k [symbol] . The basis elements of the η-fermion space ∧ⁿVₙ are |\vec{z} [symbol] =∧ₖ₌₁^{η}|zₖ [symbol] =|z₁ [symbol] ∧ . . . ∧|z_{η} [symbol] , where dim

$$[ {∧}^{n} {V}_{n} ] = ( \begin{matrix}η \\ n\end{matrix} ) .$$

These basis elements of the r-fermion space are indexed by the following set of sorted integers:

[symbol]

_{n,η}≐{\vec{z}≡(z₁, . . . ,zₙ): ∀i∈[η],1≤zⱼ<zⱼ₊₁<n}

The notation \vec{η}=[η]=(1, . . . , η) is further defined for η∈ [symbol] ⁺. In addition, the rank-1 projector onto |\vec{z} [symbol] is defined as:

Π_{\vec{z}}=|\vec{z} [symbol] [symbol] \vec{z}|=\hat{n}_{z}_{₁}\hat{n}_{z}_{₂} . . . \hat{n}_{z}_{_{η}}≐\hat{n}_{\vec{z}}

where the number operator is given by the ladder operator pair \hat{n}ⱼ=αⱼ^{†}αⱼ. When dim(\vec{z})<η, the rank-1 projection operator is given by:

$${\prod }_{\vec{z}} = {\sum }_{{\vec{z}}^{′} ∈ {n , η}_{} : \vec{z} ⊆ {\vec{z}}^{′}} {Π}_{{\vec{z}}^{′}} = {\hat{n}}_{{z}_{1}} {\hat{n}}_{{z}_{2}} … {\hat{n}}_{{z}_{dim ( \vec{z} )}}$$

In such examples, Π_{\vec{z}} is the rank

$$‐ ( \begin{matrix}n ‐ dim ( \vec{z} ) \\ η ‐ dim ( \vec{z} )\end{matrix} )$$

projector onto the space in which the sites \vec{z} are occupied.

Let u∈ [symbol] ₙ be a unitary operation on the basis elements of Vₙ, such that |uₖ [symbol] ≐Σ_{q}u_{qk}|q [symbol] . The representation U_{η}(u) on ∨ⁿVₙ is then a fermion rotation with an action given by:

$${U}_{η} ( u ) \vert \vec{z} 〉 = {⋀}_{k = 1}^{n} \vert {u}_{{z}_{k}} 〉 = {\sum }_{\vec{p} ∈ {n , η}_{}} det [ {u}_{\vec{p} \vec{z}} ] \vert \vec{p} 〉$$

In the above equation, u_{\vec{x}\vec{y}} is used to denote the submatrix formed by taking rows x₁, x₂, . . . and columns y₁, y₂, . . . of u=u_{(1, . . . , n),(1 . . . , n)}. Thus, det[u\vec{p}\vec{z}] is a minor of u. Fermion rotations are a homomorphism of [symbol] ₙ, with

U_{η}(v)U_{η}(u)|\vec{z} [symbol] =U_{η}(vu)|\vec{z}

[symbol]

The fermion rotations may also be described as single-particle basis rotations, since each creation operator is rotated to a linear combination of other creation operators as follows:

$${U}_{η} ( u ) {a}_{k}^{†} {U}_{η}^{†} ( u ) \vert 0 〉 = {\sum }_{j} {u}_{{k}_{j}} {a}_{j}^{†} \vert 0 〉$$

In addition to the rotation of a creation operator by the fermion rotation, as shown in the above equation, products of creation and annihilation operators may also be rotated. For any \vec{p}, \vec{q}∈ [symbol] _{n,k}, let the k-RDM be expressed as:

RDM_{\vec{p}\vec{q}}=αₚ_{₁}^{†} . . . αₚ_{ₖ}^{†}α_{q}_{ₖ} . . . α_{q}_{₁}

The rotated k-RDM is:

$$\begin{matrix}{U}_{η} ( u ) R D {M}_{\vec{p} , \vec{q}} {U}_{η}^{†} ( u ) = {U}_{η} ( u ) {a}_{{p}_{1}}^{†} … {a}_{{p}_{k}}^{†} {U}_{η}^{†} ( u ) {U}_{η} ( u ) {a}_{{q}_{k}} … {a}_{{q}_{1}} {U}_{η}^{†} ( u ) \\ = {\sum }_{{\vec{p}}^{′} ∈ {𝒮}_{n , k}} det [ {u}_{\vec{p} {\vec{p}}^{′}} ] {a}_{{p}_{1}^{′}}^{†} … {a}_{{p}_{k}^{′}}^{†} \\ {\sum }_{{\vec{q}}^{′} ∈ {𝒮}_{n , k}} det [ {u}_{{\vec{q}}^{′} \vec{q}}^{†} ] {a}_{{q}_{k}^{′}} … {a}_{{q}_{1}}^{′} \\ = {\sum }_{{\vec{p}}^{′} ∈ {𝒮}_{n , k}} {\sum }_{{\vec{q}}^{′} ∈ {𝒮}_{n , k}} det [ {u}_{\vec{p} {\vec{p}}^{′}} ] det [ {u}_{{\vec{q}}^{′} \vec{q}}^{†} ] R D {M}_{{\vec{p}}^{′} , {\vec{q}}^{′}}\end{matrix}$$

For an observable O expressed as a linear combination of coefficient matrices O= [symbol] o\vec{q}\vec{p}RDM_{\vec{p}\vec{q}}, the rotated observable may be expressed as:

$$\begin{matrix}U ( u ) {OU}^{†} ( u ) = {\sum }_{{\vec{p}}^{′} ∈ {𝒮}_{n , k}} {\sum }_{{\vec{q}}^{′} ∈ {𝒮}_{n , k}} \\ ( {\sum }_{\vec{p} , \vec{q} ∈ {𝒮}_{n , k}} det [ {u}_{{\vec{q}}^{′} \vec{q}}^{†} ] {o}_{\vec{q} , \vec{p}} det [ {u}_{\vec{p} {\vec{p}}^{′}} ] ) {a}_{{p}_{1}^{′}}^{†} … {a}_{{p}_{k}^{′}}^{†} {a}_{{q}_{k}^{′}} … {a}_{{q}_{1}^{′}} \\ = {\sum }_{{\vec{p}}^{′} ∈ {𝒮}_{n , k}} {\sum }_{{\vec{q}}^{′} ∈ {𝒮}_{n , k}} \\ ( {\sum }_{\vec{p} , \vec{q} ∈ {𝒮}_{n , k}} {( {U}_{k}^{†} ( u ) )}_{{\vec{q}}^{′} , \vec{q}} {{o}_{\vec{q} , \vec{p}} ( {U}_{k} ( u ) )}_{\vec{p} , {\vec{p}}^{′}} ) {a}_{{p}_{1}^{′}}^{†} … {a}_{{p}_{k}^{′}}^{†} {a}_{{q}_{k}^{′}} … {a}_{{q}_{1}^{′}} \\ = {\sum }_{{\vec{p}}^{′} , {\vec{q}}^{′} ∈ {𝒮}_{n , k}} {( {U}_{k}^{†} ( u ) \cdot o \cdot {U}_{k} ( u ) )}_{{\vec{p}}^{′} , {\vec{q}}^{′}} {a}_{{p}_{1}^{′}}^{†} … {a}_{{p}_{k}^{′}}^{†} {a}_{{q}_{k}^{′}} … {a}_{{q}_{1}^{′}}\end{matrix}$$

In the above equation for the rotated observable, conjugation by the dimension

$$- ( \begin{matrix}n \\ η\end{matrix} )$$

unitary matrix U_{η}(u) is equivalent to conjugation by the smaller dimension

$$- ( \begin{matrix}n \\ k\end{matrix} )$$

unitary matrix Uₖ(u). The subscript on U_{η}(u) is dropped below, since the order η of the exterior product may be inferred from context.

Formalism related to Haar integration is provided below. In this example, the Haar-random unitary matrix u is randomized with respect to orbital rotations U^{⊗t}(u). The corresponding twirling operators are linear in the basis of Weingarten integrals. This linearity in the basis of Weingarten integrals allows quantities such as the measurement channel and the shadow variance to be computed without requiring t-design results.

The twirling operator of degree t on ∨ₖ₌₁^{η} [symbol] ₙ with respect to the Haar measure on [symbol] ₙ is:

[symbol]

_{T,n,η}=∫_{u˜U}_{ₙ}(U_{η}(u)|\vec{η} [symbol] \vec{η}|U_{η}^{†}(u))^{⊗t}du

where |\vec{η} [symbol] ≐∨ₖ₌₁^{η}|k [symbol] and |k [symbol] are orthonormal bases for ∨ₖ₌₁^{η} [symbol] ₙ and [symbol] ₙ, respectively.

The basis (\vec{i}, \vec{i′}, \vec{j}, \vec{j′}) Weingarten integral of degree t on [symbol] ₙ is defined as:

$${\int }_{u ∼ {𝒰}_{n}} {u}_{{i}_{1} {j}_{1}} … {u}_{{i}_{q} {j}_{q}} {u}_{{j}_{1}^{′} {i}_{1}^{′}}^{†} … {u}_{{j}_{q}^{′} {i}_{q}^{′}}^{†} d u = {\sum }_{π , γ ∈ {S}_{q}} {δ}_{\vec{ι} , π ( {\vec{ι}}^{′} )} {δ}_{{γ}^{- 1} ( \vec{j} ) , {\vec{j}}^{′}} {Wg}^{{𝒰}_{n}} ( {πγ}^{- 1} )$$

$$where$$

$${δ}_{\vec{x} , π ( {\vec{x}}^{′} )} \dot{=} \{ \begin{matrix}1 , & ∀ j ∈ [ q ] , {x}_{j} = {x}_{π ( j )}^{′} \\ 0 , & otherwise\end{matrix}$$

In the above definition, S_{q} is the order q symmetric group. [symbol] (πγ⁻¹)= [symbol] (γ⁻¹π)= [symbol] (π⁻¹γ) is the Weingarten function, which depends only on the conjugacy class of the permutation.

Let X be a set of unique elements. Then

S_{x,d}={(X_{σ(1)}, . . . ,X_{σ(d)}):σ∈S_{|x|}}

is the set of all vectors whose elements are subsets of X with d elements. In the above equation, Sₙ is the symmetric group on n elements.

The measurement channel discussed above is invertible. Thus, the fermion rotations form a random measurement basis for the classical shadows. The measurement channel is invertible as a result of the fermion rotations being tomographically complete, meaning that a complete basis for any n-mode, η-fermion density matrix p can be formed via conjugating diagonal operators by fermion rotations. In other words, any quantum state ρ=Σ_{\vec{p}\vec{q}}ρ_{\vec{p}\vec{q}}|\vec{p} [symbol] \vec{q}| with a definite number of η fermions, written in the configuration basis, is expressible as the linear combination

$$ρ = {\sum }_{j} {α}_{j} U ( {u}_{j} ) \vert \vec{η} 〉 〈 \vec{η} \vert {U}^{†} ( {u}_{j} )$$

for some coefficients αⱼ and fermion rotations generated with U(uⱼ).

In addition to the fermion rotations being tomographically complete, the k-RDMs are also diagonal with respect to fermion rotations. For all \vec{p}, \vec{q}Σ[n], the k-RDM RDM_{\vec{p},\vec{q},ϕ}=e^{iϕ}αₚ_{₁}^{†} . . . αₚ_{ₖ}^{†}α_{q}_{ₖ} . . . α_{q}_{₁}+h.c. is diagonal with respect to fermion rotations, and the k-RDMs therefore form a complete basis for p when conjugated with the fermion rotations.

Any observable O of the fermion wavefunction ρ may be estimated from one or more classical shadows given the inverse measurement channel [symbol] _{∨}_{ⁿ}_{U}_{ₙ}⁻¹ on the pure state |\vec{η} [symbol] . Given one or more classical shadows (uⱼ, \vec{z}ⱼ), the estimate of the observable O is given by

$$\frac{1}{N} {\sum }_{j ∈ [ N ]} Tr [ O {\hat{ρ}}_{{u}_{j} , {\vec{z}}_{j}} ] ,$$

where:

Tr[O\hat{ρ}_{u,\vec{z}}]=Tr[O [symbol] _{∨}_{ⁿ}_{U}_{ₙ}⁻¹[U^{†}(u)|\vec{z} [symbol] \vec{z}|U(u)]]

Since there exists a permutation s_{z} such that U^{†}(s_{\vec{z}})|\vec{η} [symbol] =|\vec{z} [symbol] , the above equation for the estimate of the observable may be converted to the following by substituting for |\vec{z} [symbol] and commuting the fermion rotation through the measurement channel:

Tr[O\hat{ρ}u,\vec{z}]=Tr[U(s_{\vec{z}}u)OU^{†}(s_{\vec{z}}u) [symbol] _{∨}_{ⁿ}_{U}_{ₙ}⁻¹[|\vec{η} [symbol] \vec{η}|]]

Thus, the observable O may be estimated by evaluating [symbol] _{∨}_{ⁿ}_{U}_{ₙ}⁻¹[|\vec{η} [symbol] \vec{η}|]. This estimate of O may be computed as:

$${ℳ}_{{∧}^{n} {𝒰}_{n}}^{- 1} [ \vert \vec{η} 〉 〈 \vec{η} \vert ] = {\sum }_{d = 0}^{η} {a}_{d} ( \begin{matrix}n + 1 \\ d\end{matrix} ) {\sum }_{𝒳 ∈ {S}_{η , d}} {\sum }_{𝒴 = {S}_{[ n ] ∖ [ η ] , d}} {\tilde{n}}_{𝒳 , 𝒴}$$

In the above equation, the coefficients α_{d} are given by:

$${a}_{d} \dot{=} ( n - 2 d + 1 ) \frac{( n - d - η ) ! ( η - d ) !}{( n - d + 1 ) !}$$

The symmetric difference of number operators ñ_{x,y} are given by:

$${\tilde{n}}_{𝒳 , 𝒴} = {\prod }_{a = 1}^{d} ( {\hat{n}}_{{𝒳}_{a}} - {\hat{n}}_{{𝒴}_{a}} )$$

Using the above equations for the estimate of O and the inverse measurement channel [symbol] _{∨}_{ⁿ}_{U}_{ₙ}⁻¹[|\vec{η} [symbol] \vec{η}|],the expectation of any given observable O may be estimated from a set of one or more classical shadows {(uⱼ,\vec{z}ⱼ)}. The resulting expression is:

$$= \frac{1}{N} {\sum }_{j ∈ [ N ]} Tr [ U ( {s}_{\vec{z}} u ) {OU}^{†} ( {s}_{\vec{z}} u ) {ℳ}_{{∧}^{n} {𝒰}_{n}}^{- 1} [ \vert \vec{η} 〉 〈 \vec{η} \vert ] ]$$

However, computing [symbol] using a above equation has a computational complexity of [symbol] (n^{2η}), since each operator has dimension

$$( \begin{matrix}n \\ η\end{matrix} ) \times ( \begin{matrix}n \\ η\end{matrix} ) in η .$$

The approach to computing [symbol] discussed below allows [symbol] to be computed in a manner that includes multiplication of

$$( \begin{matrix}n \\ k\end{matrix} ) \times ( \begin{matrix}n \\ k\end{matrix} )$$

matrices rather than

$$( \begin{matrix}n \\ η\end{matrix} ) \times ( \begin{matrix}n \\ η\end{matrix} )$$

matrices. Thus, using the techniques discussed below, [symbol] may be computed with a computational complexity of [symbol] (n^{2k}). Since k is typically much smaller than η, significant compute savings may accordingly be achieved.

Returning to the example of FIG. 1, at the classical computing device 20, the processor 22 receives the classical shadow measurement result |\vec{z} [symbol] from the quantum computing device 12. The processor 22 then estimates a k-RDM element 32 of a k-RDM 30 of the fermion wavefunction ρ based at least in part on the classical shadow measurement result |\vec{z} [symbol] and the Haar-random unitary matrix u. Subsequently to computing the k-RDM element 32, the processor 22 outputs the k-RDM element 32 to an additional computing process 34.

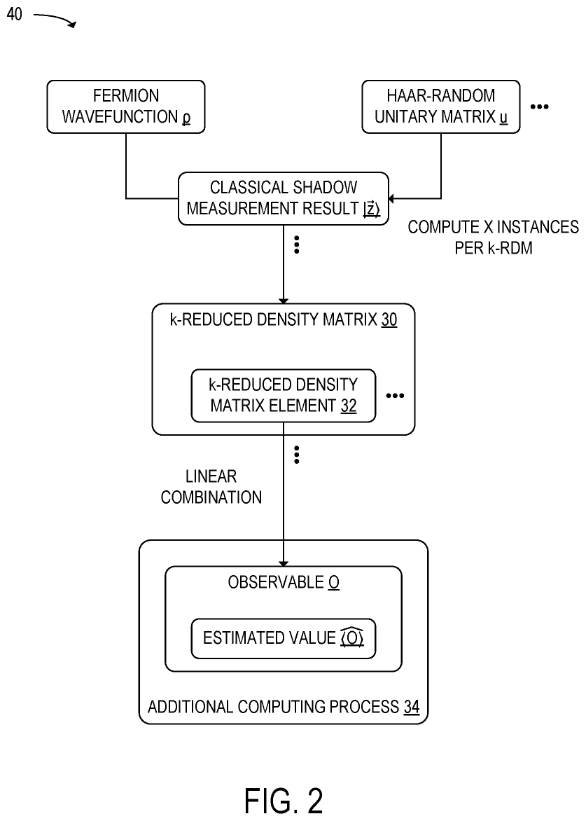

FIG. 2 shows a data flow 40 that occurs at the computing system 10 in some examples. In the example of FIG. 2, at the additional computing process 34, the processor computes an estimated value of an observable O based at least in part on the k-RDM element 32. The processor 22, as shown in the example of FIG. 2, computes a plurality of k-RDM elements 32 included in the k-RDM 30. However, in other examples, the processor 22 may compute the estimated value of O using a single k-RDM element 32.

The processor 22 may compute respective k-RDM elements 32 of a plurality of k-RDMs 30 in some examples. When the processor 22 computes a plurality of k-RDM elements 32, the quantum computing device 12 may determine a plurality of classical shadow measurement results |\vec{z} [symbol] associated with a respective plurality of Haar-random unitary matrices u. The processor 22 of the classical computing device 20 estimates the k-RDM element 32 in such examples based at least in part on the plurality of classical shadow measurement results |\vec{z} [symbol] and the corresponding Haar-random unitary matrices u. In examples in which a plurality of k-RDM elements 32 are computed, the processor 22 may further compute the estimated value [symbol] of the observable O as a linear combination of the plurality of k-RDM elements 32.

Further details related to computing the estimated value [symbol] of the observable O as a linear combination of the k-RDM elements 32 are provided below. When the observable O is expressed as a linear combination of the k-RDM elements 32, O takes the following form:

$$O = {\sum }_{\vec{p} , \vec{q}} {o}_{\vec{q} , \vec{p}} {a}_{{p}_{1}}^{†} … {a}_{{p}_{k}}^{†} {a}_{{q}_{k}} … {a}_{{q}_{1}}$$

where o_{\vec{q},\vec{p}} is a coefficient matrix.

A single-shot estimate of O computed using one k-RDM and the corresponding coefficient matrix o is given by the following:

Tr[O\vec{ρ}_{u,z}]=Tr[o·Uₖ(s_{\vec{z}}u)·D_{n,η,k}·Uₖ^{†}(s_{\vec{z}}u)]

where D_{n,η,k} is a diagonal estimation matrix. Each of the entries of the diagonal estimation matrix are given by:

$$〈 \vec{p} \vert {D}_{n , η , k} \vert \vec{p} 〉 = {( - 1 )}^{s} {( \begin{matrix}k \\ s\end{matrix} )}^{- 1} ( \begin{matrix}η - k + s \\ s\end{matrix} ) ( \begin{matrix}n - η + k - s \\ k - s\end{matrix} )$$

where s=|\vec{p}\[η]|. All of the unique entries of the diagonal estimation matrix D_{n,η,k} may be computed with complexity [symbol] (η²).

In the special case in which O=RDM_{\vec{p},\vec{q}} is a single k-RDM 30, the single-shot estimate simplifies to:

Tr[RDM_{\vec{p},\vec{q}}\vec{ρ}_{u,z}]= [symbol] \vec{p}|Uₖ(s_{\vec{z}}u)·D_{n,η,k}·Uₖ^{†}(s_{\vec{z}}u)|\vec{q}

[symbol]

Thus, in such examples, a single evaluation of

$${U}_{k} ( {s}_{\vec{z}} u ) \cdot {D}_{n , η , k} \cdot {U}_{k}^{†} ( {s}_{\vec{z}} u ) = {\sum }_{\vec{p} , \vec{q} ∈ {n , k}_{}} \vert \vec{p} 〉 〈 \vec{q} \vert Tr [ {RDM}_{\vec{p} , \vec{q}} {\hat{ρ}}_{u , \vec{z}} ]$$

provides an estimate of O for each of the k-RDMs 30 concurrently. In some examples, the processor 22 computes the estimates of the observable O in parallel using the k-RDMs 30 as shown in the above equation.

The variance of the estimated value [symbol] of the observable O is discussed below. The following notation is used for expected values:

[symbol]

ᵤ≐ [symbol] _{u˜U}_{ₙ}

[symbol]

_{u,\vec{z}}⊥ [symbol] _{u˜U}_{ₙ} [symbol] _{|\vec{z})˜U}_{_{η}}_{(u)ρU}_{_{η}}_{^{†}}₍ᵤ₎≐ [symbol] _{u˜U}_{ₙ}♮_{\vec{z}}p(\vec{z}|u,ρ)

The variance of [symbol] with respect to ρ is state-dependent and is given by:

Var_{ρ}[O]= [symbol] _{u,\vec{z}}[|Tr[O\vec{ρ}_{u,\vec{z}}]−Tr[Oρ]|²]= [symbol] _{u,\vec{z}}[|Tr[O\hat{ρ}_{u,\vec{z}}]|²]−|Tr[Oρ]|²

A state-dependent upper bound on the variance is given by the shadow norm:

$${‖ O ‖}_{shadow}^{2} \dot{=} {max}_{ρ} {‖ O ‖}_{shadow , ρ}^{2} \\ {‖ O ‖}_{shadow , ρ}^{2} \dot{=} {𝔼}_{u , \vec{z}} [ {\vert Tr [ O {\hat{ρ}}_{u , \vec{z}} ] \vert}^{2} ]$$

The average variance of concurrently estimating O over a plurality of k-RDMs 30, as discussed above, is given by:

$${𝔼}_{\vec{p} , \vec{q}} [ {‖ {RDM}_{\vec{p} , \vec{q}} ‖}_{shadow}^{2} ] = ( \begin{matrix}η \\ k\end{matrix} ) {( 1 - \frac{η - k}{n} )}^{k} \frac{1 + n}{1 + n - k}$$

Thus, since k is typically small (e.g., 1, 2, 3, or 4), the value of the observable O may be estimated with low levels of error in most examples.

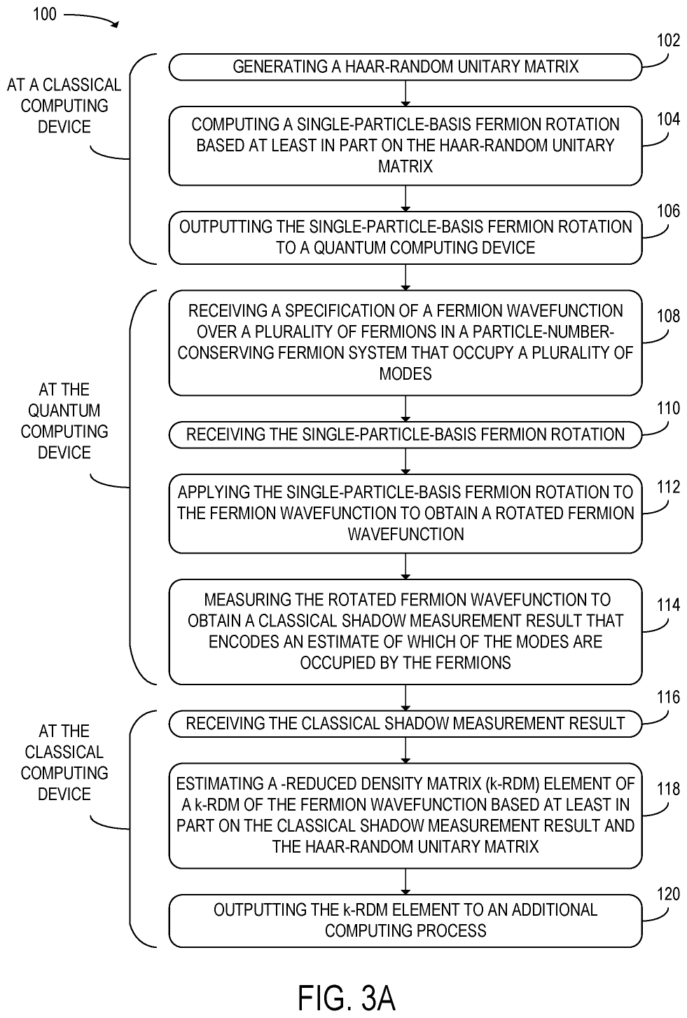

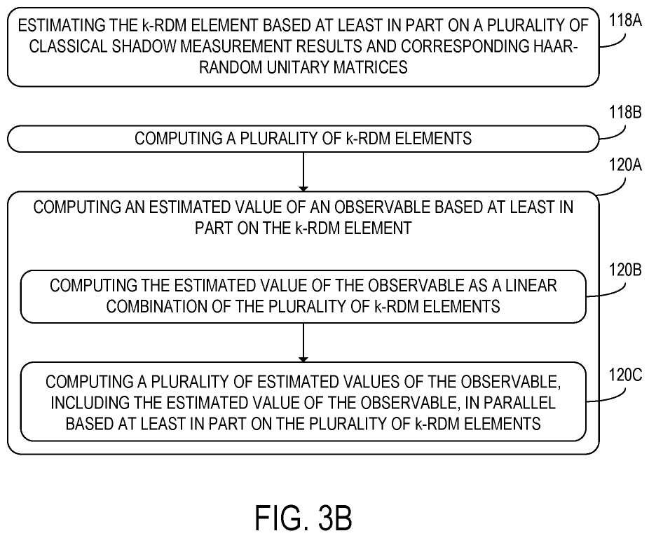

FIG. 3A shows a flowchart of a method 100 that may be used with a computing system that includes a quantum computing device and a classical computing device. In the method 100 as shown in the example of FIG. 3A, steps 102, 104, 106, 116, 118, and 120 are performed at the classical computing device and steps 108, 110, 112, and 114 are performed at the quantum computing device. The quantum computing device may, for example, be a topological quantum computing device.

At step 102, the method 100 includes generating a Haar-random unitary matrix at the classical computing device. At step 106, the method 100 further includes computing a single-particle-basis fermion rotation based at least in part on the Haar-random unitary matrix. The method 100 further includes, at step 106, outputting the single-particle-basis fermion rotation to the quantum computing device.

At step 108, the method 100 further includes, at the quantum computing device, receiving a specification of a fermion wavefunction over a plurality of fermions in a particle-number-conserving fermion system that occupy a plurality of modes. The specification of the fermion wavefunction may be received at the quantum computing device from the classical computing device. In addition, the specification of the fermion wavefunction may be expressed as a Hamiltonian that characterizes a system of fermions. For example, the fermion wavefunction may describe the electrons and atomic nuclei in a molecule simulated at the computing system. The Haar-random unitary matrix generated at step 102 has a dimension n×n, where n is a number of fermions modes for which the fermion wavefunction is specified.

At step 110, the method 100 further includes receiving the single-particle-basis fermion rotation from the classical computing device. At step 112, the method 100 further includes applying the single-particle-basis fermion rotation to the fermion wavefunction to obtain a rotated fermion wavefunction. Applying the single-particle-basis fermion rotation to the fermion wavefunction may include computing the product UρU^{†}, where U is the single-particle-basis fermion rotation, ρ is the fermion wavefunction, and U^{†} is the conjugate transpose of the single-particle-basis fermion rotation.

At step 114, the method 100 further includes measuring the rotated fermion wavefunction to obtain a classical shadow measurement result that encodes an estimate of which of the modes are occupied by the fermions. The classical shadow measurement result may be expressed as a bitstring. Thus, the classical shadow measurement result may be generated in a form in which classical computing operations may be performed on it.

At step 116, the method 110 further includes receiving the classical shadow measurement result at the classical computing device. In some examples, the classical shadow measurement result and/or the Haar-random unitary matrix may be stored in memory included in the classical computing device.

At step 118, the method 110 further includes estimating a k-RDM element of a k-RDM of the fermion wavefunction based at least in part on the classical shadow measurement result and the Haar-random unitary matrix.

FIG. 3B shows additional steps of the method 100 that may be performed in some examples. Step 118A, as shown in FIG. 3B, may be performed in examples in which the classical shadow measurement result is included among a plurality of classical shadow measurement results generated at the quantum computing device. In such examples, the classical shadow measurement results are generated at the quantum computing device based at least in part on a respective plurality of Haar-random unitary matrices that includes the Haar-random unitary matrix. At step 118A, step 118 may include, at the classical computing device, estimating the k-RDM element based at least in part on the plurality of classical shadow measurement results and the corresponding Haar-random unitary matrices. By utilizing a plurality of classical shadow measurement results and the corresponding Haar-random unitary matrices, a more accurate estimate of the k-RDM element may be obtained.

In some examples, as shown in FIG. 3B at step 118B, step 118 may additionally or alternatively include computing a plurality of k-RDM elements. In some examples, the plurality of k-RDM elements may be included in a full k-RDM approximated at the classical computing device.

Returning to FIG. 3A, at step 120, the method 100 may further include outputting the k-RDM element to an additional computing process. For example, the additional computing process may be included in a quantum chemistry simulation program. At step 120A, as shown in FIG. 3B, step 120 may include computing an estimated value of an observable based at least in part on the k-RDM element. The observable may, for example, be an energy, a dipole moment, or some other observable quantity of the quantum-mechanical system that includes the plurality of fermions. The estimated value of the observable may be computed with an operator dimension of

$$( \begin{matrix}n \\ k\end{matrix} ) \times ( \begin{matrix}n \\ k\end{matrix} ) ,$$

where n is the number of modes and k is a number of ladder operator pairs with which the k-RDM element is computed. In addition, the estimate of the k-RDM element may be computed with a sample complexity of

$$N = ( \frac{1}{{ϵ}^{2}} \frac{{η}^{k}}{k !} ) ,$$

where ∈ is a standard deviation of the estimate of the k-RDM element and η is a number of fermions for which the fermion wavefunction is specified.

In examples in which step 118B is performed, the step 120 may further include, at step 120B, computing the estimated value of the observable as a linear combination of the plurality of k-RDM elements. Additionally or alternatively, in examples in which step 118B is performed, step 120 may further include computing a plurality of estimated values of the observable, including the estimated value of the observable, in parallel based at least in part on the plurality of k-RDM elements. Thus, a sample of multiple values of the observable may be estimated.

Using the devices and methods discussed above, k-RDM elements may be estimated in a manner that results in a super-exponential speedup in terms of sample complexity. Whereas previous approaches to k-RDM estimation have sample complexity that scales as N= [symbol] ^{(k)}/∈², the devices and methods discussed above allow for

$$N = ( \frac{1}{{ϵ}^{2}} \frac{{η}^{k}}{k !} )$$

scaling. Thus, when k-RDM elements are computed in quantum chemistry simulations, the devices and methods discussed above may allow for significantly more efficient performance of the computing system.

As a further advantage of the devices and methods discussed above, since the classical shadow measurement results are expressed as classical bitstrings when received at the classical computing device, the classical shadow measurement results may be stored in the memory of the classical computing device and processed at subsequent times. Such computations may, in some examples, be performed without concurrent operation of the quantum computing device, thereby allowing for greater flexibility in scheduling computing tasks at the computing system.

In some embodiments, the methods and processes described herein may be tied to a computing system of one or more computing devices. In particular, such methods and processes may be implemented as a computer-application program or service, an application-programming interface (API), a library, and/or other computer-program product.

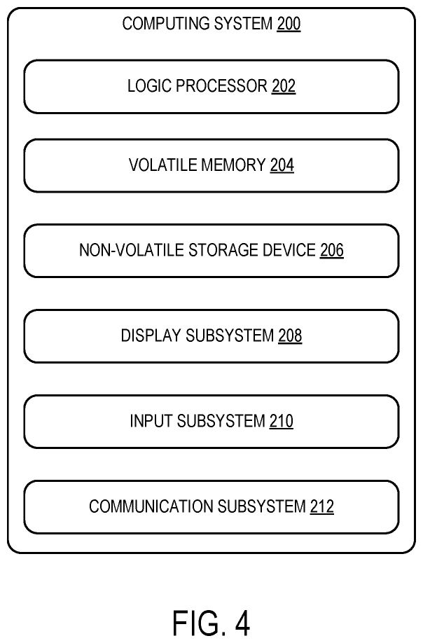

FIG. 4 schematically shows a non-limiting embodiment of a computing system 200 that can enact one or more of the methods and processes described above. Computing system 200 is shown in simplified form. Computing system 200 may embody the computing system 10 described above and illustrated in FIG. 1. Components of the computing system 200 may take the form of one or more personal computers, server computers, tablet computers, home-entertainment computers, network computing devices, video game devices, mobile computing devices, mobile communication devices (e.g., smart phone), and/or other computing devices, and wearable computing devices such as smart wristwatches and head mounted augmented reality devices.

Computing system 200 includes a logic processor 202 volatile memory 204, and a non-volatile storage device 206. Computing system 200 may optionally include a display subsystem 208, input subsystem 210, communication subsystem 212, and/or other components not shown in FIG. 2.

Logic processor 202 includes one or more physical devices configured to execute instructions. For example, the logic processor may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors (hardware) configured to execute software instructions. Additionally or alternatively, the logic processor may include one or more hardware logic circuits or firmware devices configured to execute hardware-implemented logic or firmware instructions. Processors of the logic processor 202 may be single-core or multi-core, and the instructions executed thereon may be configured for sequential, parallel, and/or distributed processing. Individual components of the logic processor optionally may be distributed among two or more separate devices, which may be remotely located and/or configured for coordinated processing. Aspects of the logic processor may be virtualized and executed by remotely accessible, networked computing devices configured in a cloud-computing configuration. In such a case, these virtualized aspects are run on different physical logic processors of various different machines, it will be understood.

Non-volatile storage device 206 includes one or more physical devices configured to hold instructions executable by the logic processors to implement the methods and processes described herein. When such methods and processes are implemented, the state of non-volatile storage device 206 may be transformed—e.g., to hold different data.

Non-volatile storage device 206 may include physical devices that are removable and/or built-in. Non-volatile storage device 206 may include optical memory, semiconductor memory, and/or magnetic memory, or other mass storage device technology. Non-volatile storage device 206 may include nonvolatile, dynamic, static, read/write, read-only, sequential-access, location-addressable, file-addressable, and/or content-addressable devices. It will be appreciated that non-volatile storage device 206 is configured to hold instructions even when power is cut to the non-volatile storage device 206.

Volatile memory 204 may include physical devices that include random access memory. Volatile memory 204 is typically utilized by logic processor 202 to temporarily store information during processing of software instructions. It will be appreciated that volatile memory 204 typically does not continue to store instructions when power is cut to the volatile memory 204.

Aspects of logic processor 202, volatile memory 204, and non-volatile storage device 206 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example. In addition, as discussed above, the computing system 200 may include a quantum computing device.

The terms “module,” “program,” and “engine” may be used to describe an aspect of computing system 200 typically implemented in software by a processor to perform a particular function using portions of volatile memory, which function involves transformative processing that specially configures the processor to perform the function. Thus, a module, program, or engine may be instantiated via logic processor 202 executing instructions held by non-volatile storage device 206, using portions of volatile memory 204. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 208 may be used to present a visual representation of data held by non-volatile storage device 206. The visual representation may take the form of a graphical user interface (GUI). As the herein described methods and processes change the data held by the non-volatile storage device, and thus transform the state of the non-volatile storage device, the state of display subsystem 208 may likewise be transformed to visually represent changes in the underlying data. Display subsystem 208 may include one or more display devices utilizing virtually any type of technology. Such display devices may be combined with logic processor 202, volatile memory 204, and/or non-volatile storage device 206 in a shared enclosure, or such display devices may be peripheral display devices.

When included, input subsystem 210 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity; and/or any other suitable sensor.

When included, communication subsystem 212 may be configured to communicatively couple various computing devices described herein with each other, and with other devices. Communication subsystem 212 may include wired and/or wireless communication devices compatible with one or more different communication protocols. As non-limiting examples, the communication subsystem may be configured for communication via a wireless telephone network, or a wired or wireless local- or wide-area network. In some embodiments, the communication subsystem may allow computing system 200 to send and/or receive messages to and/or from other devices via a network such as the Internet.

The following paragraphs discuss several aspects of the present disclosure. According to one aspect of the present disclosure, a computing system is provided, including a classical computing device. The classical computing device includes a processor that generates a Haar-random unitary matrix. The processor further computes a single-particle-basis fermion rotation based at least in part on the Haar-random unitary matrix. The processor further outputs the single-particle-basis fermion rotation to a quantum computing device. The quantum computing device receives a specification of a fermion wavefunction over a plurality of fermions in a particle-number-conserving fermion system that occupy a plurality of modes. The quantum computing device further receives the single-particle-basis fermion rotation. The quantum computing device further applies the single-particle-basis fermion rotation to the fermion wavefunction to obtain a rotated fermion wavefunction. The quantum computing device further measures the rotated fermion wavefunction to obtain a classical shadow measurement result that encodes an estimate of which of the modes are occupied by the fermions. The processor of the classical computing device further receives the classical shadow measurement result. The processor of the classical computing device further estimates a k-reduced density matrix (k-RDM) element of a k-RDM of the fermion wavefunction based at least in part on the classical shadow measurement result and the Haar-random unitary matrix. The processor of the classical computing device further outputs the k-RDM element to an additional computing process. The above features may have the technical effect of estimating the k-RDM element with a low sample complexity. The above features may also have the technical effect of allowing the classical shadow measurement result to be processed asynchronously from operation of the quantum computing device.

According to this aspect, the classical shadow measurement result may be included among a plurality of classical shadow measurement results generated at the quantum computing device based at least in part on a respective plurality of Haar-random unitary matrices that includes the Haar-random unitary matrix. The processor of the classical computing device may estimate the k-RDM element based at least in part on the plurality of classical shadow measurement results and the corresponding Haar-random unitary matrices. The above features may have the technical effect of allowing the k-RDM element to be estimated with greater accuracy.

According to this aspect, at the additional computing process, the processor may compute an estimated value of an observable based at least in part on the k-RDM element. This feature may have the technical effect of computing a quantity of interest related to the fermion system.

According to this aspect, the classical shadow measurement result may be included among a plurality of classical shadow measurement results generated at the quantum computing device based at least in part on a respective plurality of Haar-random unitary matrices that includes the Haar-random unitary matrix. The processor of the classical computing device may further compute a plurality of k-RDM elements. The processor may further compute the estimated value of the observable as a linear combination of the plurality of k-RDM elements. The above features may have the technical effect of allowing the processor to estimate the observable with greater accuracy.

According to this aspect, the classical shadow measurement result may be included among a plurality of classical shadow measurement results generated at the quantum computing device based at least in part on a respective plurality of Haar-random unitary matrices that includes the Haar-random unitary matrix. The processor of the classical computing device may further compute a plurality of k-RDM elements. The processor may further compute a plurality of estimated values of the observable, including the estimated value of the observable, in parallel based at least in part on the plurality of k-RDM elements. The above features may have the technical effect of efficiently computing values of the observable.

According to this aspect, the processor may compute the estimate of the k-RDM element with a sample complexity of

$$N = ( \frac{1}{{ϵ}^{2}} \frac{{η}^{k}}{k !} ) ,$$

where ∈ is a standard deviation of the estimate of the k-RDM element, η is a number of fermions for which the fermion wavefunction is specified, and k is a number of ladder operator pairs with which the processor computes the k-RDM element. The above features may have the technical effect of estimating the k-RDM element with a low sample complexity.

According to this aspect, the processor may compute the estimated value of the observable with an operator dimension of

$$( \begin{matrix}n \\ k\end{matrix} ) \times ( \begin{matrix}n \\ k\end{matrix} ) ,$$

where n is the number of modes and k is a number of ladder operator pairs with which the processor computes the k-RDM element. The above features may have the technical effect of reducing the sizes of matrices that are multiplied when computing the k-RDM element.

According to this aspect, the Haar-random unitary matrix may have a dimension n×n, where n is a number of modes for which the fermion wavefunction is specified. The above features may have the technical effect of allowing the processor to efficiently compute the single-particle basis fermion rotation.

According to this aspect, the quantum computing device may be a topological quantum computing device. This feature may have the technical effect of allowing the quantum computing device to compute the rotated fermion wavefunction via topological braiding operations performed on the fermion wavefunction.

According to this aspect, the additional computing process may include storing the k-RDM element in memory. This feature may have the technical effect of allowing the processor to compute one or more additional quantities using the k-RDM element asynchronously from operation of the quantum computing device.

According to another aspect of the present disclosure, a method for use with a computing system is provided. The method includes, at a classical computing device, generating a Haar-random unitary matrix. The method further includes, at the classical computing device, computing a single-particle-basis fermion rotation based at least in part on the Haar-random unitary matrix. The method further includes, at the classical computing device, outputting the single-particle-basis fermion rotation to a quantum computing device. The method further includes, at the quantum computing device, receiving a specification of a fermion wavefunction over a plurality of fermions in a particle-number-conserving fermion system that occupy a plurality of modes. The method further includes, at the quantum computing device, receiving the single-particle-basis fermion rotation. The method further includes, at the quantum computing device, applying the single-particle-basis fermion rotation to the fermion wavefunction to obtain a rotated fermion wavefunction. The method further includes, at the quantum computing device, measuring the rotated fermion wavefunction to obtain a classical shadow measurement result that encodes an estimate of which of the modes are occupied by the fermions. The method further includes, at the classical computing device, receiving the classical shadow measurement result. The method further includes, at the classical computing device, estimating a k-reduced density matrix (k-RDM) element of a k-RDM of the fermion wavefunction based at least in part on the classical shadow measurement result and the Haar-random unitary matrix. The method further includes, at the classical computing device, outputting the k-RDM element to an additional computing process. The above features may have the technical effect of estimating the k-RDM element with a low sample complexity. The above features may also have the technical effect of allowing the classical shadow measurement result to be processed asynchronously from operation of the quantum computing device.

According to this aspect, the classical shadow measurement result may be included among a plurality of classical shadow measurement results generated at the quantum computing device based at least in part on a respective plurality of Haar-random unitary matrices that includes the Haar-random unitary matrix. The method may further include, at the classical computing device, estimating the k-RDM element based at least in part on the plurality of classical shadow measurement results and the corresponding Haar-random unitary matrices. The above features may have the technical effect of allowing the k-RDM element to be estimated with greater accuracy.

According to this aspect, the method may further include, at the additional computing process, computing an estimated value of an observable based at least in part on the k-RDM element. This feature may have the technical effect of computing a quantity of interest related to the fermion system.

According to this aspect, the classical shadow measurement result may be included among a plurality of classical shadow measurement results generated at the quantum computing device based at least in part on a respective plurality of Haar-random unitary matrices that includes the Haar-random unitary matrix. The method may further include, at the classical computing device, computing a plurality of k-RDM elements and computing the estimated value of the observable as a linear combination of the plurality of k-RDM elements. The above features may have the technical effect of allowing the observable to be estimated with greater accuracy.

According to this aspect, the classical shadow measurement result may be included among a plurality of classical shadow measurement results generated at the quantum computing device based at least in part on a respective plurality of Haar-random unitary matrices that includes the Haar-random unitary matrix. The method may further include, at the classical computing device, computing a plurality of k-RDM elements. The method may further include, at the classical computing device, computing a plurality of estimated values of the observable, including the estimated value of the observable, in parallel based at least in part on the plurality of k-RDM elements. The above features may have the technical effect of efficiently computing values of the observable.

According to this aspect, the estimate of the k-RDM element may be computed with a sample complexity of

$$N = ( \frac{1}{{ϵ}^{2}} \frac{{η}^{k}}{k !} ) ,$$

where ∈ is a standard deviation of the estimate of the k-RDM element, η is a number of fermions for which the fermion wavefunction is specified, and k is a number of ladder operator pairs with which the k-RDM element is computed. The above features may have the technical effect of estimating the k-RDM element with a low sample complexity.

According to this aspect, the estimated value of the observable may be computed with an operator dimension of

$$( \begin{matrix}n \\ k\end{matrix} ) \times ( \begin{matrix}n \\ k\end{matrix} ) ,$$

where n is the number of modes and k is a number of ladder operator pairs with which the k-RDM element is computed. The above features may have the technical effect of reducing the sizes of matrices that are multiplied when computing the k-RDM element.

According to this aspect, the Haar-random unitary matrix may have a dimension n×n, where n is a number of modes for which the fermion wavefunction is specified. The above features may have the technical effect of allowing the processor to efficiently compute the single-particle basis fermion rotation.

According to this aspect, the quantum computing device may be a topological quantum computing device. This feature may have the technical effect of allowing the quantum computing device to compute the rotated fermion wavefunction via topological braiding operations performed on the fermion wavefunction.

According to another aspect of the present disclosure, a computing system is provided, including a classical computing device. The classical computing device may include a processor that generates a plurality of Haar-random unitary matrices. The processor further computes a plurality of single-particle-basis fermion rotations based at least in part on the Haar-random unitary matrices. The processor further outputs the plurality of single-particle-basis fermion rotations to a quantum computing device. The quantum computing device receives a specification of a fermion wavefunction over a plurality of fermions in a particle-number-conserving fermion system that occupy a plurality of modes. The quantum computing device further receives the plurality of single-particle-basis fermion rotations. The quantum computing device further applies each of the single-particle-basis fermion rotations to the fermion wavefunction to obtain a plurality of rotated fermion wavefunctions. The quantum computing device further measures the rotated fermion wavefunctions to obtain a plurality of classical shadow measurement results that encode respective estimates of which of the modes are occupied by the fermions. The processor of the classical computing device further receives the classical shadow measurement results and the corresponding Haar-random unitary matrices. The processor further estimates, in parallel, a plurality of k-reduced density matrices (k-RDMs) the fermion wavefunction based at least in part on the classical shadow measurement results and the Haar-random unitary matrices. The processor further computes an estimated value of an observable based at least in part on the plurality of k-RDMs. The processor further outputs the estimated value of the observable. The above features may have the technical effect of estimating the observable with a low sample complexity. The above features may also have the technical effect of allowing the classical shadow measurement result to be processed asynchronously from operation of the quantum computing device.

“And/or” as used herein is defined as the inclusive or v, as specified by the following truth table:

| A | B | A ∨ B |
|---|---|---|
| True | True | True |
| True | False | True |
| False | True | True |
| False | False | False |

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A computing system comprising:
a classical computing device including a processor that:
generates a Haar-random unitary matrix;
computes a single-particle-basis fermion rotation based at least in part on the Haar-random unitary matrix; and
outputs the single-particle-basis fermion rotation to a quantum computing device, wherein:
the quantum computing device:
receives a specification of a fermion wavefunction over a plurality of fermions in a particle-number-conserving fermion system that occupy a plurality of modes;
receives the single-particle-basis fermion rotation;
applies the single-particle-basis fermion rotation to the fermion wavefunction to obtain a rotated fermion wavefunction; and
measures the rotated fermion wavefunction to obtain a classical shadow measurement result that encodes an estimate of which of the modes are occupied by the fermions; and
the processor of the classical computing device further:
receives the classical shadow measurement result;
estimates a k-reduced density matrix (k-RDM) element of a k-RDM of the fermion wavefunction based at least in part on the classical shadow measurement result and the Haar-random unitary matrix; and
outputs the k-RDM element to an additional computing process.

2. The computing system of claim 1, wherein:
the classical shadow measurement result is included among a plurality of classical shadow measurement results generated at the quantum computing device based at least in part on a respective plurality of Haar-random unitary matrices that includes the Haar-random unitary matrix; and
the processor of the classical computing device estimates the k-RDM element based at least in part on the plurality of classical shadow measurement results and the corresponding Haar-random unitary matrices.

3. The computing system of claim 1, wherein, at the additional computing process, the processor computes an estimated value of an observable based at least in part on the k-RDM element.

4. The computing system of claim 3, wherein:
the classical shadow measurement result is included among a plurality of classical shadow measurement results generated at the quantum computing device based at least in part on a respective plurality of Haar-random unitary matrices that includes the Haar-random unitary matrix; and
the processor of the classical computing device further:
computes a plurality of k-RDM elements; and
computes the estimated value of the observable as a linear combination of the plurality of k-RDM elements.

5. The computing system of claim 3, wherein:
the classical shadow measurement result is included among a plurality of classical shadow measurement results generated at the quantum computing device based at least in part on a respective plurality of Haar-random unitary matrices that includes the Haar-random unitary matrix; and
the processor of the classical computing device further:
computes a plurality of k-RDM elements; and
computes a plurality of estimated values of the observable, including the estimated value of the observable, in parallel based at least in part on the plurality of k-RDM elements.

6. The computing system of claim 5, wherein the processor computes the estimate of the k-RDM element with a sample complexity of
$$N = ( \frac{1}{{ϵ}^{2}} \frac{{η}^{k}}{k !} ) ,$$
here ∈ is a standard deviation of the estimate of the k-RDM element, η is a number of fermions for which the fermion wavefunction is specified, and k is a number of ladder operator pairs with which the processor computes the k-RDM element.

7. The computing system of claim 3, wherein the processor computes the estimated value of the observable with an operator dimension of
$$( \begin{matrix}n \\ k\end{matrix} ) \times ( \begin{matrix}n \\ k\end{matrix} ) ,$$
where n is the number of modes and k is a number of ladder operator pairs with which the processor computes the k-RDM element.

8. The computing system of claim 1, wherein the Haar-random unitary matrix has a dimension n×n, where n is a number of modes for which the fermion wavefunction is specified.

9. The computing system of claim 1, wherein the quantum computing device is a topological quantum computing device.

10. The computing system of claim 1, wherein the additional computing process includes storing the k-RDM element in memory.

11. A method for use with a computing system, the method comprising:
at a classical computing device:
generating a Haar-random unitary matrix;
computing a single-particle-basis fermion rotation based at least in part on the Haar-random unitary matrix; and
outputting the single-particle-basis fermion rotation to a quantum computing device;
at the quantum computing device:
receiving a specification of a fermion wavefunction over a plurality of fermions in a particle-number-conserving fermion system that occupy a plurality of modes;
receiving the single-particle-basis fermion rotation;
applying the single-particle-basis fermion rotation to the fermion wavefunction to obtain a rotated fermion wavefunction; and
measuring the rotated fermion wavefunction to obtain a classical shadow measurement result that encodes an estimate of which of the modes are occupied by the fermions; and
at the classical computing device:
receiving the classical shadow measurement result;
estimating a k-reduced density matrix (k-RDM) element of a k-RDM of the fermion wavefunction based at least in part on the classical shadow measurement result and the Haar-random unitary matrix; and
outputting the k-RDM element to an additional computing process.

12. The method of claim 11, wherein:
the classical shadow measurement result is included among a plurality of classical shadow measurement results generated at the quantum computing device based at least in part on a respective plurality of Haar-random unitary matrices that includes the Haar-random unitary matrix; and
the method further comprises, at the classical computing device, estimating the k-RDM element based at least in part on the plurality of classical shadow measurement results and the corresponding Haar-random unitary matrices.

13. The method of claim 11, further comprising, at the additional computing process, computing an estimated value of an observable based at least in part on the k-RDM element.

14. The method of claim 13, wherein:
the classical shadow measurement result is included among a plurality of classical shadow measurement results generated at the quantum computing device based at least in part on a respective plurality of Haar-random unitary matrices that includes the Haar-random unitary matrix; and
the method further comprises, at the classical computing device:
computing a plurality of k-RDM elements; and
computing the estimated value of the observable as a linear combination of the plurality of k-RDM elements.

15. The method of claim 13, wherein:
the classical shadow measurement result is included among a plurality of classical shadow measurement results generated at the quantum computing device based at least in part on a respective plurality of Haar-random unitary matrices that includes the Haar-random unitary matrix; and
the method further comprises, at the classical computing device:
computing a plurality of k-RDM elements; and
computing a plurality of estimated values of the observable, including the estimated value of the observable, in parallel based at least in part on the plurality of k-RDM elements.

16. The method of claim 15, wherein the estimate of the k-RDM element is computed with a sample complexity of
$$N = ( \frac{1}{{ϵ}^{2}} \frac{{η}^{k}}{k !} ) ,$$
where ∈ is a standard deviation of the estimate of the k-RDM element, η is a number of fermions for which the fermion wavefunction is specified, and k is a number of ladder operator pairs with which the k-RDM element is computed.

17. The method of claim 13, wherein the estimated value of the observable is computed with an operator dimension of
$$( \begin{matrix}n \\ k\end{matrix} ) \times ( \begin{matrix}n \\ k\end{matrix} ) ,$$
where n is the number of modes and k is a number of ladder operator pairs with which the k-RDM element is computed.

18. The method of claim 11, wherein the Haar-random unitary matrix has a dimension n×n, where n is a number of modes for which the fermion wavefunction is specified.

19. The method of claim 11, wherein the quantum computing device is a topological quantum computing device.

20. A computing system comprising:
a classical computing device including a processor that:
generates a plurality of Haar-random unitary matrices;
computes a plurality of single-particle-basis fermion rotations based at least in part on the Haar-random unitary matrices; and
outputs the plurality of single-particle-basis fermion rotations to a quantum computing device, wherein:
the quantum computing device:
receives a specification of a fermion wavefunction over a plurality of fermions in a particle-number-conserving fermion system that occupy a plurality of modes;
receives the plurality of single-particle-basis fermion rotations;
applies each of the single-particle-basis fermion rotations to the fermion wavefunction to obtain a plurality of rotated fermion wavefunctions; and
measures the rotated fermion wavefunctions to obtain a plurality of classical shadow measurement results that encode respective estimates of which of the modes are occupied by the fermions; and
the processor of the classical computing device further:
receives the classical shadow measurement results and the corresponding Haar-random unitary matrices;
estimates, in parallel, a plurality of k-reduced density matrices (k-RDMs) the fermion wavefunction based at least in part on the classical shadow measurement results and the Haar-random unitary matrices;
computes an estimated value of an observable based at least in part on the plurality of k-RDMs; and
outputs the estimated value of the observable.
